(19) United States
(12) Patent Application Publication
(10) Pub. No.: US 2007/0277644 A1
(43) Pub. Date: Dec. 6, 2007

(54) Flex Plate with Welded Rim

(76) Inventors: Anthony W. KING, Hudson, IN (US); Brett Peters, Auburn, IN (US)

Correspondence Address: MAGNA INTERNATIONAL, INC., 337 MAGNA DRIVE, AURORA, ON, L4G-7K1, US

(21) Appl. No.: 11/757,599

(22) Filed: Jun. 4, 2007

Related U.S. Application Data
(60) Provisional application No. 60/811,286, filed on Jun. 6, 2006.

(51) Int. Cl. F16C 15/00

(52) U.S. Cl. 74/572.2

(57) ABSTRACT

A two-piece flywheel for use with an automotive engine includes a central plate having an annular periphery surrounded by a ring gear. The ring gear includes an outer circumference having a plurality of radially-outwardly extending gear teeth and an inner circumference. The inner circumference of the ring gear is seam welded continuously about 360 degrees to the annular periphery of the central plate.

### FIELD OF THE INVENTION

The invention relates primarily to flywheels, and more particularly to a flywheel and method for manufacturing a flywheel for use with an automotive engine.

### DESCRIPTION OF RELATED ART

A flywheel, or flexplate, is a well known component in an automotive vehicle. As appreciated, the flywheel operates as a mechanical coupling between an output of an engine and a torque converter, which is an input of a transmission. Specifically, one side of the flywheel is mounted to an engine crankshaft and another side is mounted to the torque converter. Rotation of the crankshaft causes the flywheel to rotate which thus causes the torque converter to rotate, all in unison since directly connected. Consequently, the flywheel transmits engine torque to the torque converter which connects, multiplies and interrupts the flow of engine torque to the transmission.

Additionally, the flywheel serves as an engagement point for a pinion gear of an electric starter motor. When the electric starter motor receives an electric current from a storage battery, the pinion gear is automatically brought into engagement with the flywheel and rotated, thereby causing the flywheel and hence the crankshaft to rotate. Once the engine has started, that is, once the engine commences operation via the typical internal combustion cycle, the pinion gear is automatically disengaged, and the flywheel continues to rotate due to the movement of the crankshaft.

Referring to the prior art, a conventional two-piece flywheel 100 is detailed in FIGS. 1 and 2. The flywheel 100 includes a central plate, generally indicated at 102, of rotatably stiff but axially flexible relatively thin sheet metal. The central plate 102 is of generally constant axial thickness although variable thickness metal could be used if desired. The central plate 102 has a generally flat outer portion 104 and a slightly dished central portion 106. The central portion 106 includes a central opening 108 surrounded by a plurality of smaller openings 110 for aligning and mounting the flywheel 100 to the crankshaft 112. The degree of dishing is optional and depends primarily upon the space available between the crankshaft 112 and the torque converter 114. A plurality of annularly spaced apertures 116 extend through the outer portion 104 for mounting the flywheel 100 to the torque converter 114.

Beyond the outer portion 104, the central plate 102 includes an annular periphery 118. The annular periphery 118 defines a flange 120 extending away from the central plate 102 at approximately 90 degrees. A ring gear, generally indicated at 122, is sized to surround the annular periphery 118 and includes a plurality of radially-outwardly extending gear teeth 124 adapted to engage mating teeth on the pinion gear 126 of the electric starter motor. The ring gear 122 is intermittently fillet welded at 128 to a distal end of the flange 120 using a MIG welding process. It is also known in the art to intermittently fillet weld the ring gear 122 to the annular periphery 118 of the flange 120. Further, some prior art arrangements omit the flange 120 and intermittently fillet weld the ring gear 122 directly to the annular periphery 118.

Inherent in the design and construction of this two-piece flywheel 100 are such problems as: (1) lack of concentricity and gear teeth run-out, in which the ring gear 122 is not perfectly matched to the annular periphery 118 of the central plate 102 and in which case the gear teeth 124 therefore vary in radial distance from the crankshaft 112; (2) warping of the ring gear 122 and/or central plate 102 due to heat affected zones from the fillet welds 128, thus causing tolerances to be affected; and (3) weld spatter on the gear teeth 124 and the crankshaft and torque converter mounting surfaces due to the MIG welding process, thus requiring additional inspection and removal steps.

A second conventional flywheel is disclosed in U.S. Pat. No. 4,462,269 (the '269 patent) to Inglis. The '269 patent discloses a one-piece flywheel including a generally flat, central plate having a central opening surrounded by a plurality of smaller openings for aligning and mounting the flywheel to the crankshaft, and a ring gear integrally formed with and positioned around the central plate. The ring gear includes radially-outwardly extending gear teeth adapted to engage the mating teeth on the pinion gear. A separate and distinct reinforcement segment or member is supplied in overlapping relationship with the gear teeth of the ring gear to provide additional strength to the gear teeth where the pinion gear is initially engaged.

Although this one-piece flywheel reduces concentricity and gear teeth run-out issues, as well as eliminates the welding issues, the one-piece design has its own inherent problems when compared to the two-piece flywheel 100. Specifically, the two-piece flywheel 100 is well known and widely used because the central plate 102 and ring gear 122 are manufactured of different materials selected to provide specific characteristics during operation of the flywheel 100. A typical central plate 102 would be made from material complying with S.A.E. J1392. In contrast, the ring gear 122 would typically be made from material such as S.A.E. 1038 to 1055 steel with carbon, heat-treated to a Rockwell “C” hardness of between 40 and 80. Using the different materials allows the central plate 102 to flex to a limited extent to help absorb and transmit forces exerted upon it during engagement with the pinion gear 126, while the ring gear 122 is designed to resist repeated impacts by the mating teeth of the pinion gear 126. Consequently, it is desirable to provide a two-piece flywheel and a method for manufacturing the two-piece flywheel that includes a ring gear fixedly secured continuously about 360 degrees to a central plate prior to hobbing the gear teeth thereby reducing concentricity and gear teeth run-out issues while maintaining the advantage of using different materials for the central plate and ring gear.

### SUMMARY OF THE INVENTION

According to one aspect of the invention, a two-piece flywheel for use with an automotive engine includes a central plate having an annular periphery surrounded by a ring gear. The ring gear includes an outer circumference having a plurality of radially-outwardly extending gear teeth and an inner circumference. The inner circumference of the ring gear is seam welded continuously about 360 degrees to the annular periphery of the central plate.

According to another aspect of the invention, a method for manufacturing a two-piece flywheel is disclosed. The flywheel includes a central plate having an annular periphery surrounded by a ring gear having an outer circumference with a plurality of radially-outwardly extending gear teeth and an inner circumference. The method includes the following steps. First, the inner circumference of the ring gear is press-fit about the annular periphery of the central plate. Next, the inner circumference of the ring gear is fixedly secured continuously about 360 degrees to the annular periphery of the central plate. The plurality of radially-outwardly extending gear teeth are then hobbed in the outer circumference of the ring gear. Finally, the ring gear is heat treated.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a plan view illustrating a conventional two-piece flywheel;

FIG. 2 is a cross-sectional view illustrating the conventional two-piece flywheel of FIG. 1 disposed between an engine crankshaft and torque converter;

FIG. 3 is a plan view illustrating a two-piece flywheel according to the invention;

FIG. 4 is a cross-sectional view illustrating the two-piece flywheel of FIG. 3 disposed between the engine crankshaft and torque converter;

FIG. 5 is a cross-sectional view illustrating a pair of wheel electrodes seam welding the two-piece flywheel;

FIG. 6 is a cross-sectional view illustrating a second embodiment of the two-piece flywheel;

FIG. 7 is a fragmentary, enlarged cross-sectional view illustrating the second embodiment of the two-piece flywheel with an inner wheel electrode for deforming a flange; and

FIG. 8 is a cross-sectional view illustrating a third embodiment with the pair of wheel electrodes seam welding the two-piece flywheel.

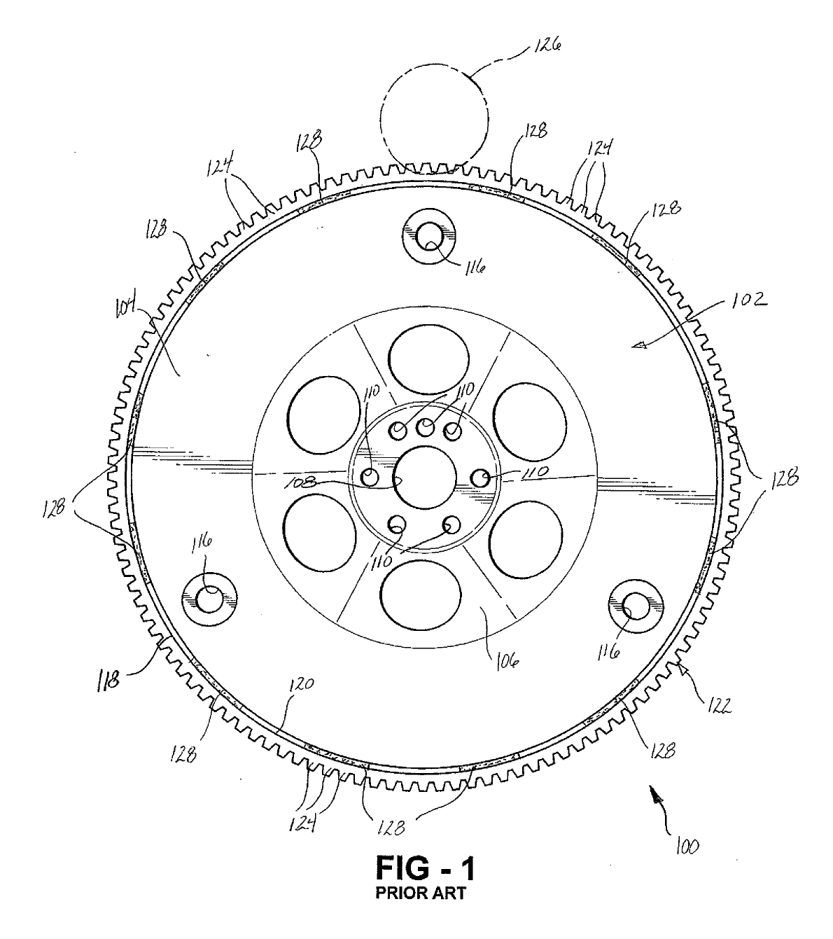

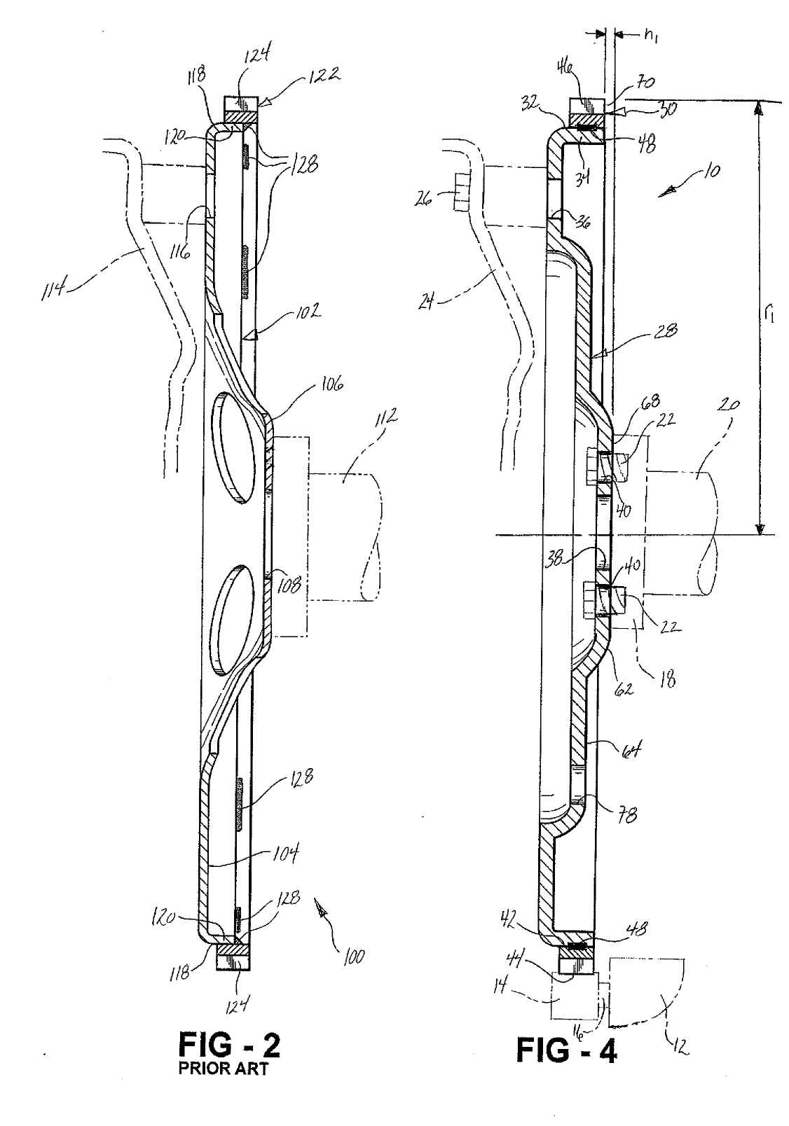

### DETAILED DESCRIPTION OF THE PREFERRED EMBODIMENTS

Referring to the Figures, wherein like numerals indicate like or corresponding parts throughout the several views, a two-piece flywheel or flexplate, manufactured according to the subject invention is generally shown at 10. Referring initially to FIG. 4, the flywheel 10 manufactured according to the subject invention is disposed between and provided for connecting an internal combustion engine (not shown in the Figures) and a transmission (not shown in the Figures) in an automotive vehicle (not shown in the Figures). An electric starter motor 12 includes a pinion gear 14 located on a drive shaft 16 rotatably coupled to the electric starter motor 12. As explained earlier, the pinion gear 14 of the starter motor 12 is brought into engagement with the flywheel 10 and rotated to start the engine. The pinion gear 14 is normally only in engagement with the flywheel 10 when the engine is being started, and is automatically withdrawn from engagement once the engine is started.

More specifically, the flywheel 10 is mounted to a hub 18 of an engine crankshaft 20 via mounting bolts 22. The flywheel 10 is also mounted to a torque converter 24, which is an input of the transmission, via mounting bolts 26. Rotation of the crankshaft 20 causes the flywheel 10 to rotate which thus causes the torque converter 24 to rotate, all in unison since directly connected. Consequently, the flywheel 10 transmits engine torque to the torque converter 24 which connects, multiplies and interrupts the flow of engine torque to the automatic transmission.

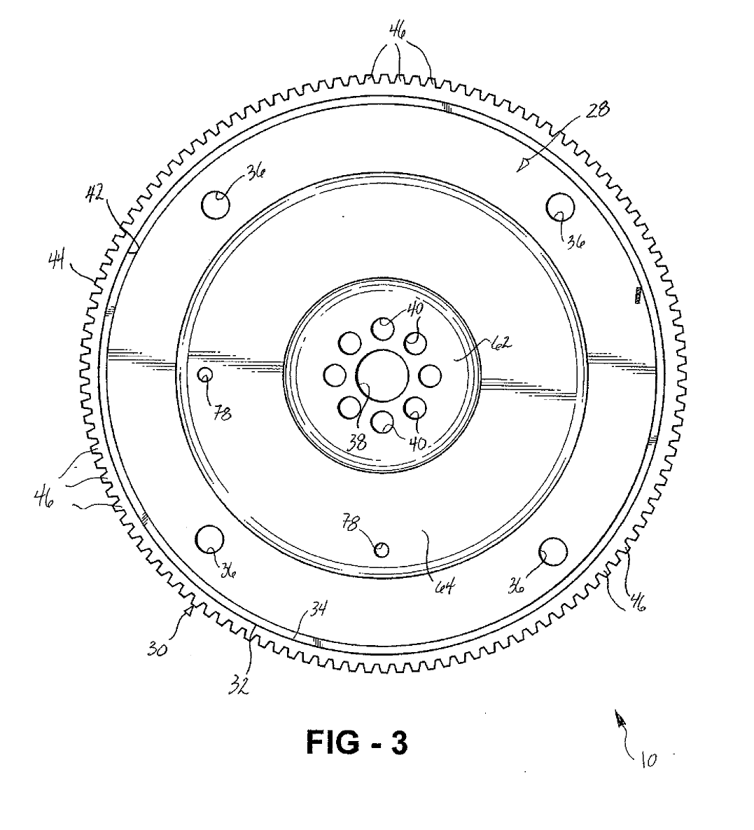

Referring now to FIGS. 3 and 4, the flywheel 10 includes a central plate, generally indicated at 28, surrounded by a ring gear, generally indicated at 30, fixedly secured thereto. The central plate 28 is a generally flat unitary stamping having an annular outer periphery 32 defined by an axially extending flange 34. As appreciated, the central plate 28 of the flywheel 10 is rotatably stiff but axially flexible such that it will flex to a limited extent to help absorb and transmit forces exerted upon it during engagement with the pinion gear 14 of the electric starter motor 12. The central plate 28 includes a plurality of apertures 36 for receiving the mounting bolts 26, or other fasteners necessary to properly secure the flywheel 10 to the torque converter 24. The central plate 28 terminates at a central opening 38 for aligning and mounting the flywheel 10 to the crankshaft 20. The central opening 38 is surrounded by a plurality of smaller openings 40 for receiving the mounting bolts 22, or other fasteners necessary to properly secure the flywheel 10 to the hub 18 of the crankshaft 20. The central plate 28 has a central dish-shape with the axially extending flange 34 formed in an opposite axial direction as the central dish-shape, such that the ring gear 30 is radially aligned with the central dish-shape of the central plate 28.

The ring gear 30 of the flywheel 10 includes an inner circumference 42 and an outer circumference 44 having a plurality of radially-outwardly extending gear teeth 46. The inner circumference 42 of the ring gear 30 is disposed about the annular periphery 32 of the central plate 28 and sized such that it is in press-fit engagement with the flange 34. The inner circumference 42 is welded to the flange 34 by a continuous seam weld 48 or roll spot weld extending 360 degrees about the flywheel 10, as shown in FIG. 4. The plurality of gear teeth 46 are of a pitch and depth so as to engage with a plurality of mating teeth (not shown in the Figures) on the pinion gear 14 of the electric starter motor 12. The plurality of gear teeth 46 will vary with the type of engine, size of the flywheel 10, and type of pinion gear 14 used with the electric starter motor 12.

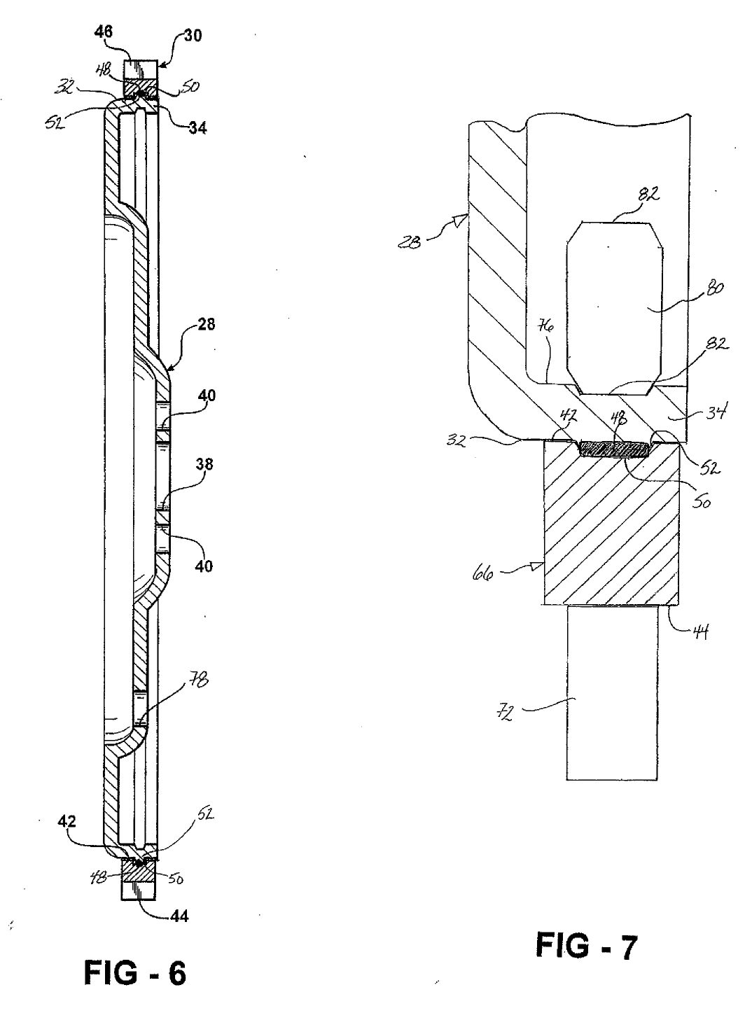

Referring to FIGS. 6 and 7, in a second embodiment, the inner circumference 42 of the ring gear 30 includes a circumferential groove 50 extending therearound. The annular periphery 32 of the flange 34 includes a circumferential rib 52 extending therearound. The inner circumference 42 of the ring gear 30 is disposed about the annular periphery 32 of the central plate 28 and sized such that it is in press-fit engagement with the flange 34. The rib 52 projecting from the annular periphery 32 of the flange 34 is disposed in the groove 50 lockingly coupling the ring gear 30 and the central plate 28. Additionally, the inner circumference 42 is welded to the flange 34 at the interface between the rib 52 and groove 50 by the continuous seam weld 48 extending 360 degrees about the flywheel 10.

The subject invention further includes a method for manufacturing the two-piece flywheel 10 including the central plate 28 having the axially extending flange 34 at the annular periphery 32 surrounded by the ring gear 30 having the outer circumference 44 with the plurality of radially-outwardly extending gear teeth 46 and the inner circumference 42. The method includes an initial step of providing a central plate 28 pre-manufactured to include the axially extending flange 34 at the annular periphery 32, the plurality of apertures 36, the central opening 38, and the plurality of smaller openings 40, as described above and shown in FIGS. 3 and 4. The central plate 28 may be formed to include a center stepped portion 62 and an outer stepped portion 64, as shown in FIG. 4. The central plate 28 is preferably made from material complying with S.A.E. J1392.

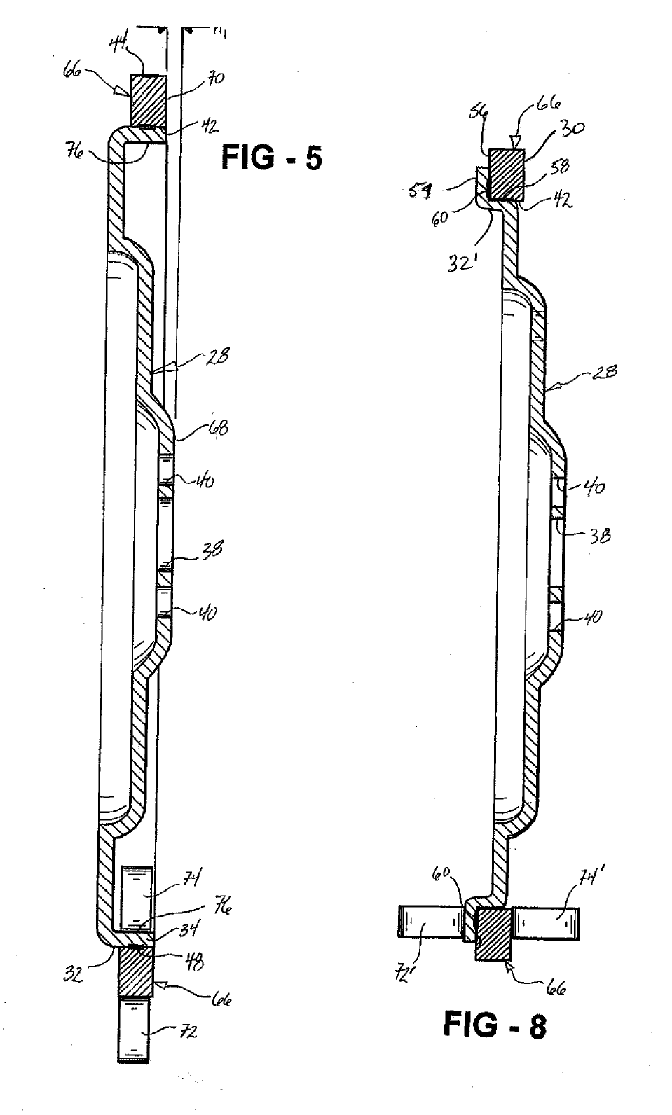

With reference to FIG. 5, the method also includes the step of providing a ring gear blank, generally indicated at 66, pre-manufactured to include the inner circumference 42 and the outer circumference 44, as described above with reference to the ring gear 30. It will be appreciated, however, that the outer circumference 44 of the ring gear blank 66 does not include the radially-outwardly extending gear teeth 46. The ring gear blank 66 is preferably made from material such as annealed S.A.E. 1038 to 1055 steel with carbon.

The method further includes the step of press-fitting the ring gear blank 66 to the central plate 28 such that the inner circumference 42 is disposed about the flange 34 at the annular periphery 32. Also during the press-fitting operation, the ring gear blank 66 is located relative to a crank datum surface 68 to establish a gear face height h₁ measured from the crank datum surface 68 to a ring gear face 70, also shown in FIG. 4.

The method next includes the step of seam welding the ring gear blank 66 to the flange 34 of the central plate 28. More specifically, two wheel shaped electrodes 72, 74, each having an axis of rotation that is parallel to the axis of rotation of the central plate 28, roll along the outer circumference 44 of the ring gear blank 66 and an inside circumference 76 of the flange 34, respectively, applying pressure and current to form the continuous seam weld 48 extending 360 degrees about the flywheel 10.

Continuing, the method is characterized by forming, either by hobbing, broaching, or cutting, the plurality of radially-outwardly extending gear teeth 46 in the outer circumference 44 of the ring gear blank 66 after it is seam welded to the central plate 28. Once the gear teeth 46 are hobbed, the flywheel 10 includes the central plate 28 surrounded by the ring gear 30, as described above. The step of hobbing the gear teeth 46 after seam welding the ring gear blank 66 to the central plate 28 ensures the flywheel 10 is capable of meeting radial run out r₁ and gear face height h₁ tolerances, shown in FIG. 4. Additionally, the flywheel 10 manufactured according to the subject invention does not necessitate the incorporation of additional steps to visually inspect for and remove weld spatter contaminating the gear teeth 46 because any such weld spatter will be removed during the step of hobbing the gear teeth 46.

Furthermore, after the gear teeth 46 are hobbed, the method includes the step of induction or flame heat-treating the ring gear 30. After heat-treating, the ring gear 30 preferably has a Rockwell “C” hardness of between 40 and 80. Finally, the flywheel 10 is balanced by conventional methods of spin balancing with balance correction holes 78 being punched or drilled in the central plate 28 as needed, and as shown in FIGS. 3 and 4.

The subject invention also includes a method for manufacturing the second embodiment of the two-piece flywheel 10 including the central plate 28 having the axially extending flange 34 at the annular periphery 32 with the circumferential rib 52 extending therearound surrounded by the ring gear 30 having the outer circumference 44 with the plurality of radially-outwardly extending gear teeth 46 and the inner circumference 42 with the circumferential groove 50 extending therearound. The method comprises the same steps as described above with respect to the preferred embodiment, however, the step of seam welding the ring gear blank 66 to the flange 34 of the central plate 28 further includes deforming a portion of the flange 34 to form the rib 52 extending into the groove 50. More specifically, referring to FIG. 7, an inner wheel shaped electrode 80 having a reduced contact surface 82 is designed such that when pressure is applied as the inner electrode 80 rolls along the inside circumference 76 of the flange 34, the rib 52 is formed therearound, extending into the groove 50.

Alternatively, the central plate 28 may be pre-manufactured to include the annular periphery 32 defined by the flange 34 with the circumferential rib 52 already extending therearound. In this case the method for manufacturing the third embodiment comprises the same steps as described above with respect to the preferred embodiment, and further includes the step of disposing the rib 52 into the groove 50 to lockingly couple the ring gear blank 66 and central plate 28 together prior to the step of seam welding the ring gear blank 66 to the central plate 28.

In a third embodiment, shown in FIG. 8, the central plate 28 is formed to include a radially extending step flange 54 adjacent the annular periphery 32′. The ring gear 30 is disposed about the annular periphery 32′ of the central plate 28 with a ring gear face 56 adjacent the step flange 54. The inner circumference 42 of the ring gear 30 is sized such that it is in press-fit engagement with an inner wall 58 of the step flange 54. The ring gear face 56 is welded to the step flange 54 by a continuous seam weld 60 extending 360 degrees about the flywheel 10.

The ring gear blank 66 is welded to the annular periphery 32′ and the step flange 54 of the central plate 28. Two wheel shaped electrodes 72′, 74′, each having an axis of rotation that is radial relative to the axis of rotation of the central plate 28, roll along the face of the ring gear blank 66 and a radial face of step flange 54, respectively, applying pressure and current to form the continuous seam weld extending 360 degrees about the flywheel 10.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed:

1. A flywheel for use with an automotive engine, said flywheel comprising:
a central plate having an annular outer periphery; and
a ring gear including an outer circumference having a plurality of radially extending gear teeth and an inner circumference, said inner circumference seam welded continuously about said annular outer periphery of said central plate.

2. A flywheel as set forth in claim 1, wherein one of said central plate and said ring gear has a circumferential groove and the other of said central plate and said ring gear has a circumferential rib interlocked with said circumferential groove.

3. A flywheel as set forth in claim 2, wherein said seam weld extends axially between said ring gear and said central plate.

3. A flywheel as set forth in claim 1, wherein said annular outer periphery has a radially extending step flange and said ring gear abuts against said step flange.

4. A flywheel as set forth in claim 3, wherein said seam weld extends radially between said ring gear and said step flange.

5. A flywheel as set forth in claim 4, wherein said ring gear is frictionally fitted onto said outer periphery.

6. A flywheel as set forth in claim 1, wherein said central plate has a central dish-shape with the annular outer periphery formed in an opposite axial direction as the central dish-shape.

7. A flywheel as set forth in claim 6, wherein said central plate has a plurality of apertures for mounting the flywheel on a hub and a plurality of apertures for mounting the flywheel onto a torque converter.

8. A method of manufacturing a flywheel comprising the steps of:
providing a central plate having an annular outer periphery;
providing a ring gear blank having an inner circumference;
press-fitting the inner circumference of the ring gear blank about the annular outer periphery of the central plate;
welding the ring gear blank continuously about the annular periphery of the central plate;
forming a plurality of radially extending gear teeth in an outer circumference of the ring gear blank; and
heat-treating the ring.

9. A method of manufacturing a flywheel as set forth in claim 8, wherein said providing steps including providing on one of said annular outer periphery and said ring gear blank with a circumferential rib and providing on the other of said annular outer periphery and said ring gear blank with a circumferential groove, and said step of press-fitting includes engaging the circumferential rib into the circumferential groove lockingly coupling the ring gear blank and central plate.

10. A method of manufacturing a flywheel as set forth in claim 9 wherein the step of welding includes seam welding and roll spot welding.

11. A method of manufacturing a flywheel as set forth in claim 9, wherein said step of providing a circumferential groove on said annular outer periphery is simultaneous with said step of welding.

12. A method of manufacturing a flywheel as set forth in claim 8, wherein said step of providing a central plate includes configuring the central plate to operatively engage a hub and a torque converter.

13. A method of manufacturing a flywheel as set forth in claim 8, wherein said step of forming includes hobbing, broaching, or cutting.

14. A method of manufacturing a flywheel comprising the steps of:
providing a central plate having an annular outer periphery and a step flange, said step flange extending radially from said outer periphery;
providing a ring gear blank having an inner circumference;
press-fitting the inner circumference of the ring gear blank about the annular outer periphery of the central plate until the ring gear abuts against said step flange;
welding the ring gear blank continuously about the step flange of the central plate;
forming a plurality of radially extending gear teeth in an outer circumference of the ring gear blank; and
heat-treating the ring.

15. A method of manufacturing a flywheel as set forth in claim 14 wherein the step of welding includes seam welding and roll spot welding.

16. A method of manufacturing a flywheel as set forth in claim 15, wherein said step of providing a central plate includes configuring the central plate to operatively engage a hub and a torque converter.

17. A method of manufacturing a flywheel as set forth in claim 16, wherein said step of forming includes hobbing, broaching, or cutting.
